(19) United States
(12) Patent Application Publication
(10) Pub. No.: US 2024/0068542 A1
(43) Pub. Date: Feb. 29, 2024

(54) DAMPING VALVE DEVICE HAVING AN EMERGENCY OPERATION FUNCTION

(71) Applicant: ZF FRIEDRICHSHAFEN AG, Friedrichshafen (DE)

(72) Inventor: Artur SCHELL, Bad Neustadt a. d. Saale (DE)

(21) Appl. No.: 18/234,531

(22) Filed: Aug. 16, 2023

(30) Foreign Application Priority Data
Aug. 23, 2022 (DE) 10 2022 208 694.5

(51) Int. Cl. F16F 9/34

(52) U.S. Cl. CPC F16F 9/34; F16F 2230/24

(57) ABSTRACT

Damping valve device, having a pre-stage valve and a main-stage valve. An actuating force on the main-stage valve body is set via the pre-stage valve, which can be adjusted by a solenoid coil. The damping valve device has an emergency operation device, which sets a defined closing force at the pre-stage valve in the event of a failure of the power supply of the damping valve device. The emergency operation device is formed by at least one permanent magnet within a magnetic flux circuit of the solenoid coil.

### BACKGROUND OF INVENTION

### 1. Field of the Invention

The disclosure relates to a damping valve device.

### 2. Description of Related Art

DE 10 2016 221 896 A1, for example, discloses a damping valve device that comprises a main-stage valve and a pre-stage valve. The pre-stage valve is used to control the main-stage valve. This enables a large hydraulic closing force to be generated at the mainstage valve with a comparatively small energy input for a solenoid coil.

In the extremely rare case where the power supply of the solenoid coil has failed, an emergency operation valve provides a control force on the pre-stage valve. The emergency operation valve comprises an annular emergency operation armature, which, from a threshold current onward, is held in a normal operating position against the force of a spring. The threshold current is selected in such a way that all the forces acting on the emergency operation armature which could move it into the emergency operating position are taken into account. DE 10 2016 221 896 A1 additionally uses a mechanical holding device, which is overcome for the emergency operating position. However, the holding device represents an additional component outlay, and this is a disadvantage, particularly because of the amount of installation space.

DE 10 2011 078 104 A1 describes a seat valve with a permanent magnet within a magnetic flux circuit of a solenoid coil, which acts on a valve armature. Depending on the activation of the solenoid coil, the resulting operating force on the valve armature is increased or reduced.

### SUMMARY OF THE INVENTION

It is the object of one aspect of the present invention to provide a damping valve device with an emergency operation function that has a mechanical structure that is simpler in comparison with the prior art.

In one aspect of the invention the emergency operation device is formed by at least one permanent magnet within a magnetic flux circuit of the solenoid coil.

The advantage consists, on the one hand, in the simple construction, but also in the fact that no moving components are necessary for the emergency operation device.

In a further advantageous embodiment, the permanent magnet is embodied as an annular body and is part of an outer housing of the damping valve device. A gain in space and a simplification of the flow paths within the hydraulic region of the damping valve device are achieved in this way.

The polarization of the permanent magnet is preferably formed between an upper and a lower cover side. This alignment of the polarization can be produced in a simple manner, and therefore the component is simpler overall.

Furthermore, it is envisaged that the cross-sectional profile of the permanent magnet has a greater radial width than an axial height. This mitigates the conflicting aims that, on the one hand, a permanent magnet with a large cross section enables large actuating forces to be exerted on the pre-stage valve, but the magnetic flux within the magnetic field is not disturbed too much by the rather flat design, since the permanent magnet entails similar disadvantages to an air gap.

There is no need for any far-reaching structural changes to the damping valve device since the permanent magnet is arranged between a housing upper part and a housing lower part.

In this case, the permanent magnet can be centered radially on the housing lower part.

In order to be able to set the damping valve device with a view to a specific damping force function in emergency operation, at least one height compensation ring is added to the permanent magnet.

### BRIEF DESCRIPTION OF THE DRAWINGS

The invention will be explained in greater detail with reference to the following description of the figures, in which:

FIG. 1 is a vibration damper with a damping valve device;

FIG. 2 is a sectional view of a damping valve device; and

FIG. 3 is a current/valve armature force diagram.

### DETAILED DESCRIPTION OF THE PRESENTLY PREFERRED EMBODIMENTS

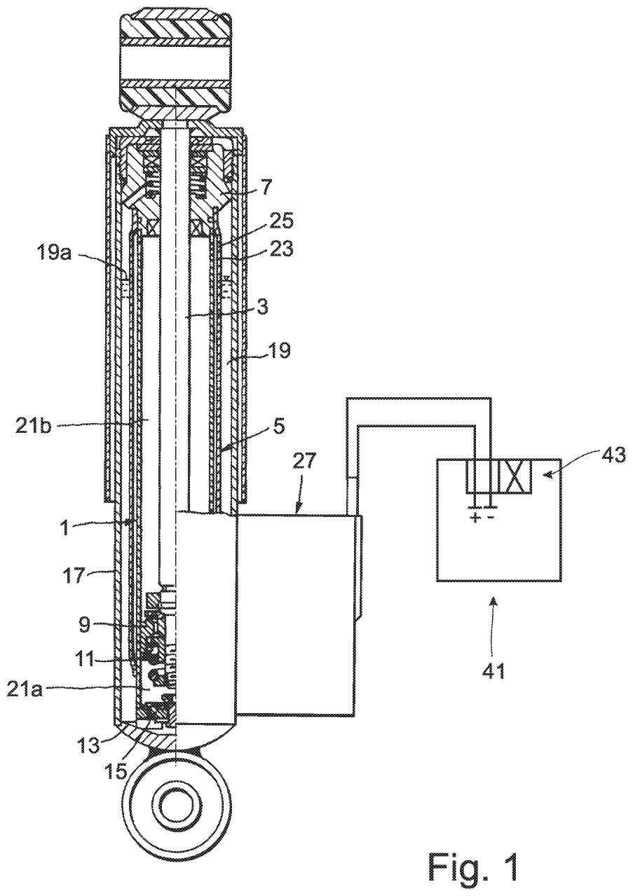

In FIG. 1, a vibration damper has a cylinder 1, in which a piston rod 3 is arranged so as to be axially movable. A guiding and sealing unit 7 guides the piston rod 3 out of the upper end of the cylinder. Within the cylinder 1, a piston unit 9 with a piston valve assembly 11 is secured on the piston rod 3. The lower end of the cylinder 1 is closed off by a bottom plate 13 with a bottom valve assembly 15. The cylinder 1 is surrounded by an outer tube 17. The outer tube 17 and an intermediate tube 5 form an annular space 19, which forms a compensating chamber. The space within the cylinder 1 is divided by the piston unit 9 into a first working chamber 21a and a second working chamber 21b. The working chambers 21a and 21b are filled with damping liquid. The compensating chamber 19 is filled up to the level 19a with liquid and above that with gas. A first line section, namely a high-pressure subsection 23, is formed within the compensating chamber 19 and is connected to the second working chamber 21b via a bore 25 of the cylinder 1. This high-pressure subsection is followed by an adjustable damping valve device 27 mounted laterally on the outer tube 17. A second line section (not shown), namely a low-pressure subsection 29, leads from the latter into the compensating chamber 19.

When the piston rod 3 is extended upward out of the cylinder 1, the upper working chamber 21b becomes smaller. An excess pressure builds up in the upper working chamber 21b, and this can only be dissipated into the lower working chamber 21a by the piston valve assembly 11 as long as the adjustable damping valve 27 is closed. When the adjustable damping valve device 27 is open, liquid flows simultaneously from the upper working chamber 21b into the compensating chamber 19 through the high-pressure subsection 23 and the adjustable damping valve device 27. The damping characteristic of the vibration damper as the piston rod 3 is extended is thus dependent on whether the adjustable damping valve device 27 is more or less open or closed.

When the piston rod 3 is retracted into the cylinder 1, an excess pressure forms in the lower working chamber 21a. Liquid can pass upward from the lower working chamber 21a into the upper working chamber 21b through the piston valve assembly 11. The liquid displaced by the increasing piston rod volume within the cylinder 1 is expelled through the bottom valve assembly 15 into the compensating chamber 19. Since the flow resistance of the piston valve assembly 11 is lower than the flow resistance of the bottom valve assembly 15, an increasing pressure likewise occurs in the upper working chamber 21b. When the damping valve device 27 is open, this rising pressure can in turn flow over into the compensating chamber 19 through the high-pressure subsection 23. This means that, with the damping valve device 27 open, the vibration damper has a softer characteristic even when it is being retracted, when the adjustable damping valve device 27 is open, and a harder characteristic when the damping valve device 27 is closed, just as when the piston rod is being extended. It should be noted that the direction of flow through the high-pressure subsection 23 of the bypass is always the same, irrespective of whether the piston rod is being retracted or extended.

The damping valve device 27 is connected to a control unit 41 which has an internal switch 43 by which the polarization of the power supply of the damping valve device 27 can be set.

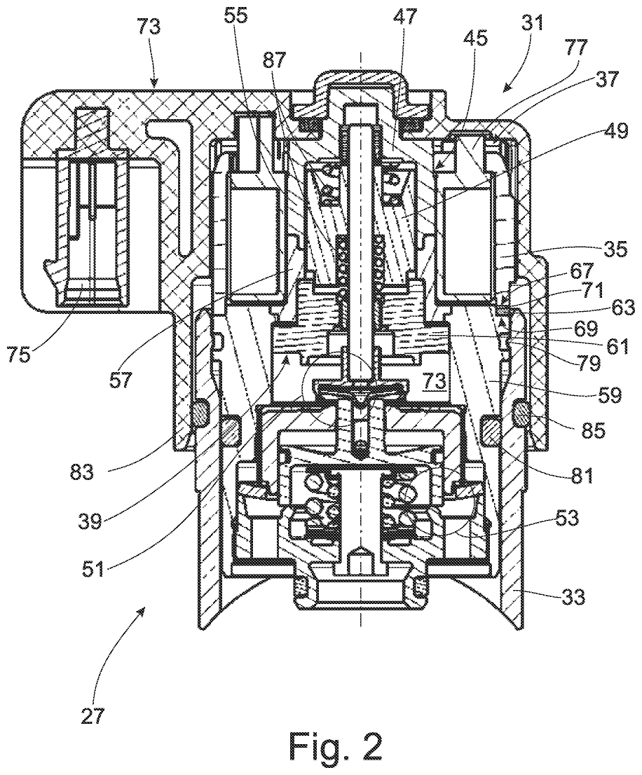

FIG. 2 shows the damping valve device 27 of FIG. 1 in a sectional view. The damping valve device 27 comprises a damping valve housing 31 with a tube part 33, which is arranged in a stationary manner with respect to the outer tube 17. A solenoid coil 37 is arranged in a housing upper part 35 as part of the damping valve housing 31. This solenoid coil is supported axially on a housing intermediate wall 39. An inner sleeve 45 with a bottom is connected in a pressure-tight manner to the housing intermediate wall 39. The housing intermediate wall 39 with the inner sleeve 45 and the bottom 47 separate a valve region from the solenoid coil 37 and the outer housing upper part 35. The inner sleeve 45 and the bottom accommodate an armature 49, by which a pre-stage valve 51 is actuated, which acts on a main-stage valve 53. The inner sleeve 45 consists of two functional sections. The bottom 47 and an inner sleeve section 55 adjoining it are produced from a material with a low magnetic resistance. An insulating sleeve 57 as part of the inner sleeve 45 has a significantly greater magnetic resistance in order to allow a magnetic flux of the coil unit 37 to flow through the armature 49 with the highest possible efficiency. In the magnetic flux of the coil unit 37, the outer housing upper part 35 forms a return body.

The housing intermediate wall 39 is also preferably of multi-part construction and comprises a housing lower part 59 and a bottom 61, which is aligned in the direction of the armature 49. The basic design of the armature 49, the pre-stage valve 51 and the main-stage valve 53 are already known by way of example from DE 10 2013 209 926 A1.

The damping valve device 27 has an emergency operation device 63 which, in the event of a failure of the power supply of the damping valve device 27 or of the coil assembly 37, sets a defined closing force at the pre-stage valve 51. The emergency operation device 63 is not formed by an additional valve component but by at least one permanent magnet within a magnetic flux circuit 65 of the coil assembly 37. The permanent magnet is embodied as an annular body and is part of the outer housing 31 of the damping valve device 27 and is arranged between the housing upper part 35 and a housing lower part 59.

The polarization of the permanent magnet 63 is formed between an upper and a lower cover side 67; 69, with the result that a magnetic flux passes axially through the permanent magnet 63. The cross-sectional profile of the permanent magnet 63 preferably has a greater radial width than an axial height. In this exemplary embodiment there is a rectangular cross section, but the invention is by no means limited to this shape.

The permanent magnet 63 is preferably centered radially on the housing lower part 59 since there is a greater wall thickness in this region and therefore no transmission losses occur in the magnetic flux owing to a centering geometry.

A height compensation ring 71 can be added to the permanent magnet 63 if, for example, a permanent magnet 63 with a lower overall height is to be used in order to introduce a lower magnetic force into the magnetic flux circuit 65.

A protective cap 73 separate from the housing upper part 35 covers the outer housing upper part 35. The protective cap 73 has a power supply connection 75, which is connected to a mating contact 77 of the protective cap 73.

The housing intermediate wall 39 is fixedly connected to the tube part 33, for example by a radial lock bead 79. A seal 81 prevents damping liquid from escaping from the valve region into the environment. The outer housing upper part 35 can be removed from the housing intermediate wall 39 even when the lock bead has already been closed.

The protective cap 73 protects not only the region of the outer housing upper part 35 and its inner components. A tubular extension 83 of the protective cap 73 is in axial overlap with the tube part 33, thus ensuring that the permanent magnet 63 is also protected. As an option, at least one seal 85 can be arranged between the inner wall of the tubular extension 83 and the tubular part 33, ensuring that the transition region between the outer housing upper part 35 and the housing intermediate wall 39 is also covered and thus protected against dirt and moisture.

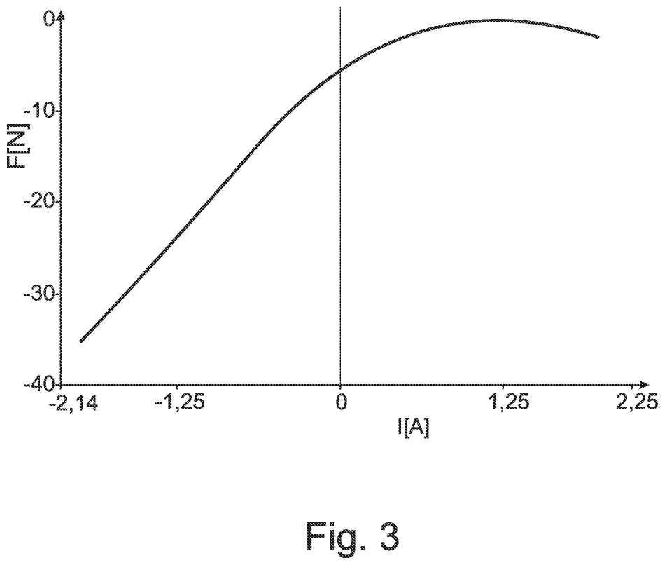

FIG. 3 shows the effect of the emergency operation device or the permanent magnet on the closing force at the pre-stage valve 51. An abscissa represents the current I which flows through the coil unit 37. In a first quadrant of the graph, a positive actuating current I causes a reduction in the closing force F. In this case, the magnetic field of the permanent magnet 63 is weakened. The required actuating current for a soft damping force characteristic curve, equal to a low closing force, is comparable to an actuating current for actuating an emergency operation valve.

In the case of a disrupted power supply of the damping valve device 27, that is to say comparable to the zero point of the graph, the closing force F on the pre-stage valve 51 is determined by springs 87 of the pre-stage valve 51 and the permanent magnet 63. When the solenoid coil 37 is energized with a current that has a reverse sign, the closing force F increases more steeply than in the case of energization with a current of the same magnitude that has a positive sign. Consequently, an increase in damping force can be achieved with a low current input. On average, there is a lower current input, in particular a low peak current input, thereby protecting the control unit 41.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A damping valve device, comprising:
a solenoid coil;
a pre-stage valve;
a main-stage valve, wherein an actuating force on the main-stage valve is set via the pre-stage valve, which can be adjusted by the solenoid coil; and
an emergency operation device, which sets a defined closing force at the prestage valve in case of a failure of a power supply of the damping valve device, comprising at least one permanent magnet within a magnetic flux circuit of the solenoid coil.

2. The damping valve device as claimed in claim 1, wherein the at least one permanent magnet is an annular body and is part of an outer housing of the damping valve device.

3. The damping valve device as claimed in claim 1, wherein a polarization of the at least one permanent magnet is formed between an upper and a lower cover side.

4. The damping valve device as claimed in claim 1, wherein a cross-sectional profile of the at least one permanent magnet has a greater radial width than an axial height.

5. The damping valve device as claimed in claim 1, wherein the at least one permanent magnet is arranged between a housing upper part and a housing lower part.

6. The damping valve device as claimed in claim 5, wherein the at least one permanent magnet is centered radially on the housing lower part.

7. The damping valve device as claimed in claim 1, wherein at least one height compensation ring is added to the at least one permanent magnet.
